(19) United States
(12) Patent Application Publication
(10) Pub. No.: US 2001/0028968 A1
(43) Pub. Date: Oct. 11, 2001

(54) Fuel cell system and method of operating same

(76) Inventor: Uwe Griesmeier, Markdorf (DE)

Correspondence Address: CROWELL & MORING LLP, Intellectual Property Group, P.O. Box 14300, Washington, DC, 20044-4300, US

(21) Appl. No.: 09/796,711

(22) Filed: Mar. 2, 2001

(30) Foreign Application Priority Data
Mar. 2, 2000 (DE) 100 10 071.6-41

(51) Int. Cl. H01M 8/06

(52) U.S. Cl. 429/19; 429/20; 429/17

(57) ABSTRACT

A gas-generating device includes at least one reforming reactor, one CO shift reactor with associated cooling device and one gas cleaning unit for selective catalytic oxidation of the carbon monoxide in the hydrogen-containing gas with associated cooling device. A fuel cell is connected downstream of the gas-generating device. The cooling device associated with the CO shift reactor comprises a line for the cathode discharge air current and the cooling device associated with the gas cleaning unit comprises a line for the anode gas discharge current. During a method for starting the gas-generating device, only fuel and air are fed into the reforming reactor at the start and the fuel cell is bypassed using a bypass line. After the starting phase, water is additionally fed into the reforming reactor and the bypass line is closed.

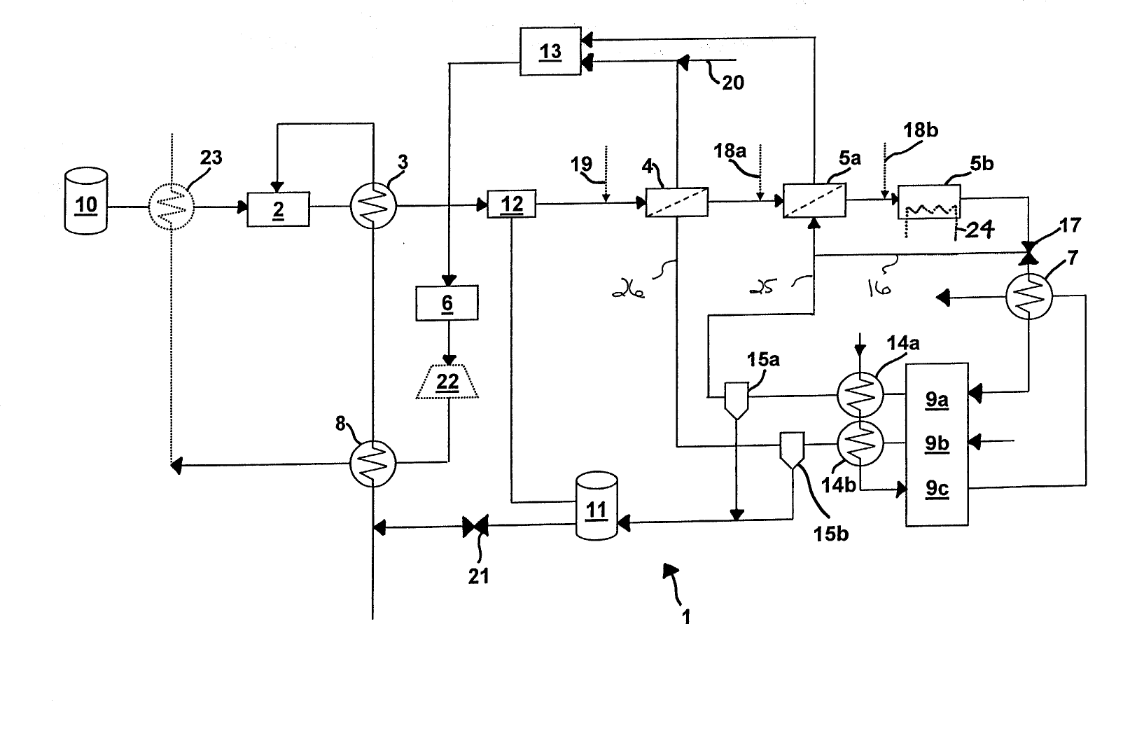

### BACKGROUND AND SUMMARY OF INVENTION

This application claims the priority of German application No. 100 100 71.6, filed Mar. 2, 2000, the disclosure of which is expressly incorporated by reference herein.

The present invention relates to a gas-generating device and a method for starting such a device.

Fuel cells have higher energy efficiency than internal combustion engines because of their method of operation, for which reason they are being increasingly used to generate current for both stationary and mobile applications. Fuel cells are usually operated with hydrogen. Because hydrogen can only be stored with difficulty, attempts have been made to store the hydrogen in the form of liquid fuels or combustibles, particularly for mobile applications, such as motor vehicles. Such fuels are, for example, pure hydrocarbons or alcohols.

For mobile applications, methanol is predominantly being used at the present. Methanol is split into hydrogen and CO₂ in a gas-generating device. The hydrogen which is generated in this way is then used to operate a fuel cell of a vehicle. However, a disadvantage is the continued absence of a methanol infrastructure and the low storage density of methanol in comparison to oil-based fuels. The high energy efficiency of a methanol fuel cell system is also virtually cancelled out by the preceding manufacture of methanol. The generation of hydrogen from conventional liquid propellants such as petrol, diesel or LPG is therefore an interesting alternative for a mobile fuel cell system. Such a fuel cell system comprises a fuel cell with a cooling medium port and an air supply as well as a gas-generating device.

U.S. Pat. No. 4,891,187 discloses a gas-generating device with (1) a reforming reactor for manufacturing a hydrogen-rich gas from a fuel, water and oxygen; (2) a shift reactor for converting carbon monoxide into hydrogen using water; and (3) a downstream gas cleaning unit for selective oxidation of carbon monoxide in the hydrogen-rich gas. Water from a water reservoir vessel (not explicitly illustrated) is fed into the shift reactor.

A gas-generating system of the generic type is known from DE 197 54 013 A1, which discloses a gas-generating unit, composed of two pre-reforming stages and one main reformer, for producing a hydrogen-rich gas. The hydrogen-rich gas is fed to the anode space of a downstream fuel cell after passing through a CO shift stage and a CO oxidation stage. The CO shift stage and the CO oxidation stage are cooled by the two pre-reforming stages.

The present invention is based on the object of providing a gas-generating device with a satisfactory level of system efficiency and a method for quickly starting such a system.

The present invention provides a gas-generating device with a high degree of thermal integration. The gas-generating device for generating a hydrogen-rich gas comprises (1) a reforming reactor for catalytic water vapor reformation and/or partial oxidation of a fuel; (2) an adjoining gas cleaning operation by means of a CO shift reactor; and (3) a downstream gas cleaning unit for selective catalytic oxidation of the carbon monoxide. The hydrogen-rich gas which is largely cleaned of carbon monoxide is fed to a downstream fuel cell.

The thermal energy required for the reforming reactor is made available by a catalytic burner in which the anode discharge gas current and the cathode discharge air current of the fuel cell are catalytically oxidized, and all the combustible components are thus removed from the discharge gases.

The anode discharge gas current is used to cool the gas cleaning unit before it enters the catalytic burner. At the same time, the cathode discharge air current is used to cool the CO shift reactor before it enters the catalytic burner. As a result, the fuel cell discharge gases are preheated before they enter the catalytic burner. This permits a high combustion temperature and a high conversion rate of the residual hydrocarbons without having to increase the stoichiometry of the fuel cell itself, which is important in particular in a system with partial oxidation of a fuel. As a result, the gas-generating device can be operated with a good level of overall efficiency. Furthermore, it is possible to dispense with different cooling circuits for the CO shift reactor and the gas cleaning device, which at the same time makes the gas-generating device more compact and improves the thermal economy. However, further cooling circuits are required to cool the selective oxidation if the CO input concentration is too high.

A further way of simplifying the thermal economy is obtained by using the energy from the discharge gases of the catalytic burner and/or the reformate gas stream emerging from the reforming reactor to preheat the educt. The discharge gas of the catalytic burner is discharged into the surroundings and is thus lost to the system. Harnessing such residual energy by preheating the educt thus further increases the overall efficiency level.

The vaporizing of water together with the heating of air makes a saving of one component. This leads to a smaller loss of pressure in the discharge gas train and thus to a higher efficiency level. The thermo-mechanical stressing of this component is also lower.

The provision of a switchable bypass line around the fuel cell makes it possible to warm up the gas-generating device independently of the fuel cell during the starting phase. This ensures that the fuel cell is not damaged by the increased CO concentration during the starting phase. At the same time, the feeding of water into the reforming reactor is prohibited during the starting phase because it is not yet possible to vaporize water in the component which is still cold.

By feeding oxygen-containing gas into the CO shift reactor, it is possible to initiate an additional oxidation reaction in the CO shift reactor during the starting phase, and addition thermal energy can thus be made available for the warming up phase. The same effect is achieved by feeding into the gas cleaning unit during the starting phase a quantity of oxygen-containing gas which exceeds the quantity necessary for the selective oxidation of the carbon monoxide. As a result, a portion of the hydrogen-rich gas which has already been generated is additionally oxidized in the gas cleaning unit and the gas cleaning unit thus warms up more quickly.

Other objects, advantages and novel features of the present invention will become apparent from the following detailed description of the invention when considered in conjunction with the accompanying drawing.

### BRIEF DESCRIPTION OF THE DRAWING

The sole FIGURE shows a gas-generating device according to the present invention.

### DETAILED DESCRIPTION OF THE DRAWING

The gas-generating device 1 according to the present invention comprises a reforming reactor 2; a CO shift reactor 4; a two-stage gas cleaning unit 5a, 5b; a catalytic burner 6; and vaporizer 8. At least one fuel cell 9, which comprises an anode 9a, a cathode 9b and a cooling space 9c through which a cooling medium flows, is connected to the gas-generating device 1. For the sake of clarity, only a single fuel cell is illustrated in the FIGURE, but in practice a fuel cell block which is formed from a stack of a plurality of fuel cells is provided. Furthermore, a fuel reservoir vessel 10 and a water reservoir vessel 11 are provided.

It is known that hydrogen can be generated from a fuel in the reforming reactor 2 by a partial oxidation reformation process, referred to below as POX reformation, in accordance with the equation:

—(CH₂)—+½ O₂ (air)→H₂+CO

and/or the endothermic vapor reformation according to the equation:

—(CH₂)—+2H₂O→3H₂+CO₂.

A combination of the two processes is also possible, giving rise to an autothermic mode of operation.

The reforming reactor 2 is operated with liquid fuel and atmospheric oxygen or water. In order to be fed with liquid fuel, the reforming reactor 2 is directly connected to the fuel reservoir vessel 10 via a line. The required water is fed from the water reservoir vessel 11 into a line for feeding in the atmospheric oxygen, and is subsequently vaporized in the vaporizer 8. The vaporizer 8 is heated using the discharge gases of the catalytic burner 6.

After the stream has passed through the vaporizer 8, further thermal energy is supplied to the water vapor/air mixture in a heat exchanger 3 using the hot reformate gas stream emerging from the reforming reactor 2. The reformate gas stream, that is to say the hydrogen-containing gas with carbon monoxide components, is cooled in the process. The reformate gas stream is subsequently subjected to further cooling in the component 12 by feeding in water from the water reservoir vessel 11. In the process, the water is vaporized in the hot reformate gas stream. The water vapor which is produced in the process is then required, in addition to the water vapor already contained in the reformate gas stream, for the shift reaction in the CO shift reactor 4. The CO portion in the reformate gas stream is converted as far as possible into hydrogen and carbon monoxide using the water vapor.

The liquid fuel from the fuel reservoir vessel 10 is not vaporized before it enters the reforming reactor 2. Instead, the liquid fuel is fed directly into the hot water vapor/air mixture and vaporized in the process. However, in order to increase the educt temperature and thus improve the efficiency, it is also possible optionally to provide a fuel vaporizer 23 (illustrated by broken lines). The reforming reactor 2 is filled with a suitable catalytic material, for example a noble metal catalytic converter. Depending on the composition of the educt, the reforming reactor 2 is operated as a POX reactor (i.e. as a reactor for a pure partial oxidation reformation) or additionally as a water-vapor reforming reactor, that is autothermically.

The hydrogen-containing reformate gas stream with carbon monoxide components subsequently passes through the CO shift reactor 4 and the gas cleaning units 5a, 5b. The CO component remaining in the reformate gas stream after passing through the CO shift reactor 4 is selectively oxidized in the gas cleaning units 5a, 5b after an oxygen-containing medium, for example atmospheric oxygen, has been fed in via corresponding lines 18a, 18b. Such devices for selective oxidation are known from the prior art, as are CO shift reactors. While the first gas cleaning unit 5a is cooled, the second gas cleaning unit 5b is operated adiabatically. As an option here, an additional water cooling circuit 24 (represented by broken lines) may also be provided. Of course, it is also possible to integrate in each case a plurality of subunits, for example also water cooled, into the CO shift reactor 4 or the gas cleaning units 5a, 5b.

The hydrogen-rich reformate gas stream is subsequently fed to the anode 9a of the fuel cell 9 while the cathode 9b of the fuel cell 9 is supplied with an oxygen-containing gas, preferably atmospheric oxygen, via an additional line. In order to cool the fuel cell 9, a cooling space 9c through which a cooling medium flows is also provided. Further heat exchangers 14a, 14b, 7 are provided in this cooling circuit. The reformate gas stream emerging from the gas cleaning unit 5b is largely reduced to the temperature level of the fuel cell 9 in the heat exchanger 7 using the cooling medium. The cooling medium is very suitable for this because when it leaves the fuel cell 9 it has approximately the same temperature level as the fuel cell 9 itself. The cooling medium is subsequently cooled by a radiator (not illustrated). Before it enters the fuel cell 9, the cooling medium is conducted through two further heat exchangers 14a, 14b. The anode discharge gas current and/or the cathode discharge air current simultaneously also flow through these heat exchangers 14a, 14b. As a result of this cooling, water which is located in the anode discharge gas stream or cathode discharge air stream is condensed out in corresponding condensers 15a, 15b and fed back into the water reservoir vessel 11.

The cathode discharge air stream is subsequently conducted through the CO shift reactor 4 in order to cool the CO shift reactor 4, and preheat the discharged air for combustion in the catalytic burner 6. The anode discharge gas stream is conducted through the gas cleaning unit 5a in order to cool the gas cleaning unit 5 and also preheat the discharge gas for combustion in the catalytic burner 6. The lines 25 and 26 are combined upstream of the catalytic burner 6 using a mixer 13, with the result that the residual hydrogen in the anode discharge gas can be used as fuel in the catalytic burner 6. However, it is also possible to feed additional atmospheric oxygen or even additional fuel, for example from the fuel reservoir vessel 10, into the catalytic burner 6.

The preheating both of the anode discharge gas stream and of the cathode discharge air stream before entry into the catalytic converter 6 makes possible a high combustion temperature and a high conversion rate of the residual hydrocarbons without having to increase the stoichiometry of the fuel cell 9 and thus worsen the system efficiency. As a result, it is possible, in particular, in a fuel cell system with a partial oxidation process of the fuel, to ensure sufficient discharge gas cleaning accompanied by a good overall efficiency level. Furthermore, the overall efficiency of the gas-generating device 1 described is increased by the high degree of thermal integration.

The CO shift reactor 4 and the gas cleaning unit 5a are illustrated in the drawing, for the sake of simplicity, as heat exchangers through which the cathode discharge air stream and/or anode discharge gas stream flow directly. However, it is also possible to provide separate heat exchangers upstream of the CO shift reactor 4 and/or of the gas cleaning unit 5a to convey the thermal energy from the reformate gas stream to the anode discharge gas stream or cathode discharge air stream. Correspondingly, the vaporizer 8 and catalytic burner 6 which are illustrated as separate components may also be integrated in one component. In order to increase the overall efficiency, an expansion turbine 22 (illustrated by broken lines) for recovering the energy contained in the discharge gas may also optionally be provided. In the exemplary embodiment illustrated, the expansion turbine 22 is arranged between the catalytic burner 6 and vaporizer 8. However, it can also be arranged further downstream, in which case less discharge gas energy can then be recovered.

In order to start the gas-generating device 1, a bypass line 16 with an associated bypass valve 17 is provided. This switchable bypass line 16 can be used to conduct the reformate gas stream directly into the catalytic burner 6, bypassing the fuel cell 9. In addition, a line 20 is provided for feeding atmospheric oxygen directly into the mixer 13, so that during the starting phase this separate air stream is made available for the catalytic burner 6, instead of the cathode discharge air stream. As a result, during the starting phase the fuel cell 9 is still not acted on by the flows of media.

In addition, a shut-off valve 21, by means of which the feeding of water into the vaporizer 8 and thus also into the reforming reactor 2 can be prevented during the starting phase, is provided between the water reservoir vessel 11 and the vaporizer. As a result, the fed-in fuel is only partially oxidized by the fed-in atmospheric oxygen during the starting phase. The additional endothermic water-vapor reformation does not take place during the starting phase. As a result, it is possible to warm up the gas-generating device 1 more quickly when starting, albeit with reduced efficiency. In order to shorten the starting phase further, it is also possible to introduce additional oxygen into the gas cleaning unit 5a, 5b during the starting phase via the lines 18a, 18b, with the result that, in addition to the selective oxidation of the carbon monoxide, a portion of the generated hydrogen is additionally oxidized, and the reactors are thus warmed up more quickly. In order to warm up the Co shift reactor 4, it is also possible to provide an additional line 19 for feeding in atmospheric oxygen during the starting phase.

After the end of the starting phase, the feeding in of the additional atmospheric oxygen is stopped. In addition, by opening the shut-off valve 21 the feeding in of water from the water reservoir vessel 11 is enabled, with the result that the reforming reactor 2 goes into its autothermic operating mode. Finally, the bypass line 16 is closed by closing the bypass valve 17, with the result that the anode space 9a of the fuel cell 9 is acted on by the reformate gas stream. At the same time, the feeding in of air into the cathode space 9b is also started, with the result that the fuel cell 9 can begin to operate.

According to the exemplary embodiment illustrated in the drawing, the bypass line 16 connects the reformate gas line between the gas cleaning unit 5b and the heat exchanger 7 to the anode discharge gas line between the condenser 5a and the gas cleaning unit 5a. However, the bypass line 16 can also branch off from the reformate gas line upstream of the gas cleaning unit 5a, 5b or of the CO shift reactor 4, or it can just open into the anode discharge gas line directly upstream of the mixer 13. A decisive factor is, on the one hand, that the entire reformate gas stream is fed via the catalytic burner 6 for discharge gas cleaning, and on the other hand that the fuel cell 9 is disconnected from the flows of media for the anode 9a, and if appropriate of the cathode 9b, so that no CO-containing gas can get into the fuel cell, even during the starting phase.

Of course, suitable metering devices may be provided in all the lines. However, for the sake of clarity, they are not illustrated in the drawing. In addition, instead of the aforesaid atmospheric oxygen, it is also possible to use any other oxygen-containing medium.

Suitable fuels are, in particular longer-chain hydrocarbons, as well as higher alcohols, petrol, diesel, LPG (Liquid Petrol Gas) and NG (Natural Gas) or dimethylether.

Although the method according to the invention and the corresponding device have been described in this application with reference to a mobile application as a preference, the range of protection is not intended to be restricted thereto, but rather is intended to extend also to a corresponding application in stationary systems.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A fuel cell system, comprising:
(A) a gas-generating device for generating a hydrogen-rich, carbon monoxide-poor gas from at least one of a water/fuel mixture by catalytic water-vapor reformation or from an oxygen/fuel mixture by partial oxidation, said gas-generating device comprising:
at least one reforming reactor;
a CO shift reactor connected to a first cooling device; and
a gas cleaning unit for the selective catalytic oxidization of carbon monoxide in a hydrogen-containing gas and connected to a second cooling device; and
(B) a fuel cell having an anode space that receives hydrogen-rich gas from the gas-generating device and a cathode space that receives an oxygen-containing gas;
wherein the first cooling device comprises a line for a cathode discharge air stream and the second cooling device comprises a line for an anode discharge gas stream.

2. A fuel cell system according to claim 1, wherein said gas-generating device further comprises a catalytic burner for producing thermal energy from the anode discharge gas stream and the cathode discharge air stream,
wherein the catalytic burner is downstream of the first and second cooling devices.

3. A fuel cell system according to claim 2, wherein said gas-generating device further comprises a heat exchanger for transmitting thermal energy from at least one of a reformate gas stream emerging from the at least one reforming reactor or from the catalytic burner to an educt which is to be fed to the reforming reactor.

4. A fuel cell system according to claim 2, wherein said gas-generating device further comprises a vaporizer that is heated directly or indirectly by the catalytic burner and is connected to a line for water and a line for an oxygen-containing medium.

5. A fuel cell system according to claim 4, wherein said gas-generating device further comprises a line for feeding liquid fuel, or fuel which is at least partially vaporized by means of a fuel vaporizer, from a fuel reservoir vessel into the reforming reactor.

6. A fuel cell system according to claim 1, wherein said gas-generating device further comprises one or more lines for feeding an oxygen-containing medium into at least one of the gas cleaning unit or into the CO shift reactor.

7. A fuel cell system according to claim 1, wherein said gas-generating device further comprises a switchable bypass line and a bypass valve for feeding the reformate gas stream emerging from the reforming reactor into the catalytic burner, thereby bypassing the fuel cell.

8. A method for starting a fuel cell system, comprising:
during a starting phase, feeding a liquid fuel from a fuel reservoir vessel and an oxygen-containing gas to a reforming reactor of a gas-generating device, and simultaneously opening a bypass line between the gas-generating device and a fuel cell;
after the starting phase, feeding water to the reforming reactor; and
during normal operation:
closing the bypass line and feeding hydrogen-rich gas from the gas-generating device to an anode space of a fuel cell;
feeding an oxygen-containing gas to a cathode space of the fuel cell;
feeding a cathode discharge air stream to a first cooling device associated with a CO shift reactor; and
feeding the anode discharge gas stream to a second cooling device associated with a gas cleaning unit.

9. A method according to claim 8, wherein during the starting phase, an oxygen-containing gas is fed into the CO shift reactor.

10. A method according to claim 8, wherein during the starting phase, a quantity of oxygen-containing gas which exceeds the quantity required for selective oxidation of the carbon monoxide is fed into the gas cleaning unit.
